(19) United States
(12) Patent Application Publication
(10) Pub. No.: US 2026/0244153 A1
(43) Pub. Date: Aug. 20, 2026

(54) IMAGING DEVICE

(71) Applicant: Panasonic Intellectual Property Management Co., Ltd., Osaka (JP)

(72) Inventors: Tomoki ZEMBUTSU, Osaka (JP); Takuya AMANO, Osaka (JP); Jun SAIKI, Hyogo (JP)

(73) Assignee: Panasonic Intellectual Property Management Co., Ltd., Osaka (JP)

(21) Appl. No.: 19/541,464

(22) Filed: Feb. 17, 2026

(30) Foreign Application Priority Data
Feb. 18, 2025 (JP) 2025-024221

(51) Int. Cl. G03G 21/16

(52) U.S. Cl. CPC G03G 21/1619; G03G 21/16; G03G 21/1633; G03G 21/1647; G03G 21/1676; G03G 2221/1654; G03G 2221/1687

(57) ABSTRACT

An imaging device includes: a housing; a cover provided on the housing to be displaceable between a first position covering a part of the housing and a second position spaced apart from the part of the housing; and a lock member provided on the cover so as to be movable between a lock position and an unlock position, the lock member being operated by a user. The cover in the first position is non-displaceable when the lock member is located in the lock position and the cover in the first position is displaceable when the lock member is located in the unlock position. The cover and the lock member respectively include first and second engagement portions that engage with each other in a moving direction of the lock member when the lock member is located at the unlock position.

### BACKGROUND

### Technical Field

The present disclosure relates to an imaging device.

### Description of the Related Art

Conventionally, there has been known an imaging device provided with a cover that is displaceable with respect to a housing and covers a part of the housing. For example, in the case of an imaging device described in JP 2022-140213 A, a cover that covers an insertion port into which a recording medium is inserted is rotatably provided in a housing. In the case of the cover described in JP 2022-140213 A, when the user slides the lock member provided on the cover, the lock of the cover is released, and the cover can be rotated with respect to the housing (the insertion port can be exposed).

### SUMMARY

Meanwhile, in a case of an imaging device in which a lock member is provided on a cover as in the imaging device described in JP 2022-140213 A, if the cover is thinned, the cover may undergo bending deformation when a user slides the lock member for unlocking. This bending deformation of the cover occurs by the user continuing to press the lock member strongly during the sliding operation in order to ensure that the lock member slides (that is, such that the user's finger does not slip on the lock member).

Therefore, an object of the present disclosure is to suppress deformation of a cover when a user operates the lock member in an imaging device in which the cover that covers a part of a housing is provided with the lock member that locks the cover in a non-displaceable manner.

In order to solve the above problem, according to an aspect of the present disclosure, an imaging device is provided that includes:

a housing;

a cover provided on the housing to be displaceable between a first position covering a part of the housing and a second position spaced apart from the part of the housing; and

a lock member provided on the cover so as to be movable between a lock position and an unlock position, the lock member being operated by a user,

wherein

the cover in the first position is non-displaceable when the lock member is located in the lock position and the cover in the first position is displaceable when the lock member is located in the unlock position; and

the cover and the lock member respectively include first and second engagement portions that engage with each other in a moving direction of the lock member when the lock member is located at the unlock position.

The present disclosure can suppress deformation of a cover when a user operates the lock member in an imaging device in which the cover that covers a part of a housing is provided with the lock member that locks the cover in a non-displaceable manner.

### BRIEF DESCRIPTION OF DRAWINGS

FIG. 1 is a front perspective view of an imaging device according to an embodiment of the present disclosure;

FIG. 2 is a rear perspective view of the imaging device;

FIG. 3A is a perspective view of the cover unit in a state where the cover is locked and is located at a first position;

FIG. 3B is a perspective view of the cover unit in a state where the cover is unlocked and is located at the first position;

FIG. 3C is a perspective view of the cover unit in a state where the cover is located at a second position;

FIG. 4A is a front exploded perspective view of the cover unit;

FIG. 4B is a rear exploded perspective view of the cover unit;

FIG. 5A is a schematic cross-sectional view of the cover unit in a state where an outer member is located at a non-rotatable position;

FIG. 5B is a schematic cross-sectional view of the cover unit in a state where the outer member is located at a rotatable position;

FIG. 6 is a schematic cross-sectional view of the cover unit in a state where the cover is located at the first position;

FIG. 7A is a perspective view of the outer member in a state where the lock member is located at the lock position;

FIG. 7B is a perspective view of the outer member in a state where the lock member is located at the unlock position;

FIG. 8A is a plan view of an inner member in a state where the lock member is located at the lock position;

FIG. 8B is a plan view of the inner member in a state where the lock member is located at the unlock position; and

FIG. 9 is a cross-sectional view of the cover in a state of being located at the second position.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the inventor(s) provides the accompanying drawings and the following description in order for those skilled in the art to fully understand the present disclosure, and does not intend to limit the subject matter described in the claims by the accompanying drawings and the following description.

Hereinafter, an imaging device according to an embodiment of the present disclosure will be described with reference to the drawings.

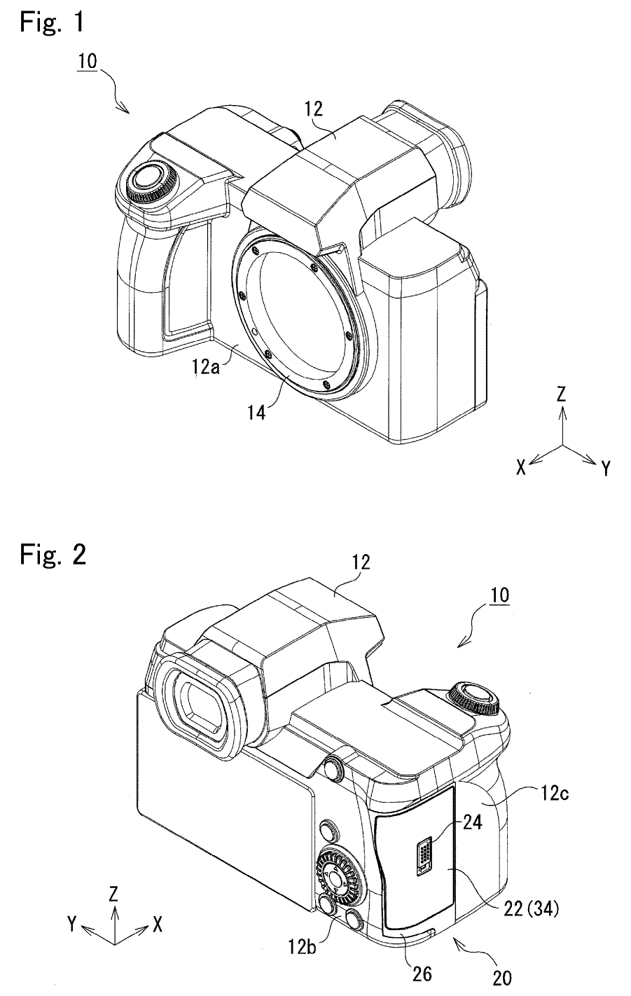

FIG. 1 is a front perspective view of an imaging device according to an embodiment of the present disclosure. In addition, FIG. 2 is a rear perspective view of the imaging device. Note that the X-Y-Z orthogonal coordinate system illustrated in the drawings is for facilitating understanding of the embodiment of the present disclosure, and does not limit the embodiment of the present disclosure. The X-axis direction is a front-rear direction of the imaging device, the Y-axis direction is a left-right direction, and the Z-axis direction is a height direction. In addition, in the present specification, the side of the imaging device on which the subject is present is referred to as “front side”, and the side on which the imaging device is present is referred to as “rear side”. In addition, “left side” and “right side” of the imaging device are “left side” and “right side” when the imaging device is viewed from the front, that is, when the imaging device is viewed from the subject side.

As illustrated in FIG. 1, an imaging device 10 according to the present embodiment is a so-called single-lens reflex camera, and includes a housing 12. The housing 12 includes a front surface 12a facing a subject during photographing, a rear surface 12b opposite to the front surface 12a, and a left side surface 12c connecting the front surface 12a and the rear surface 12b.

A lens mount 14 to which a lens (not illustrated) is detachably attached is provided on the front surface 12a of the housing 12. A cover unit 20 is provided at a corner portion between the rear surface 12b and the left side surface 12c of the housing 12.

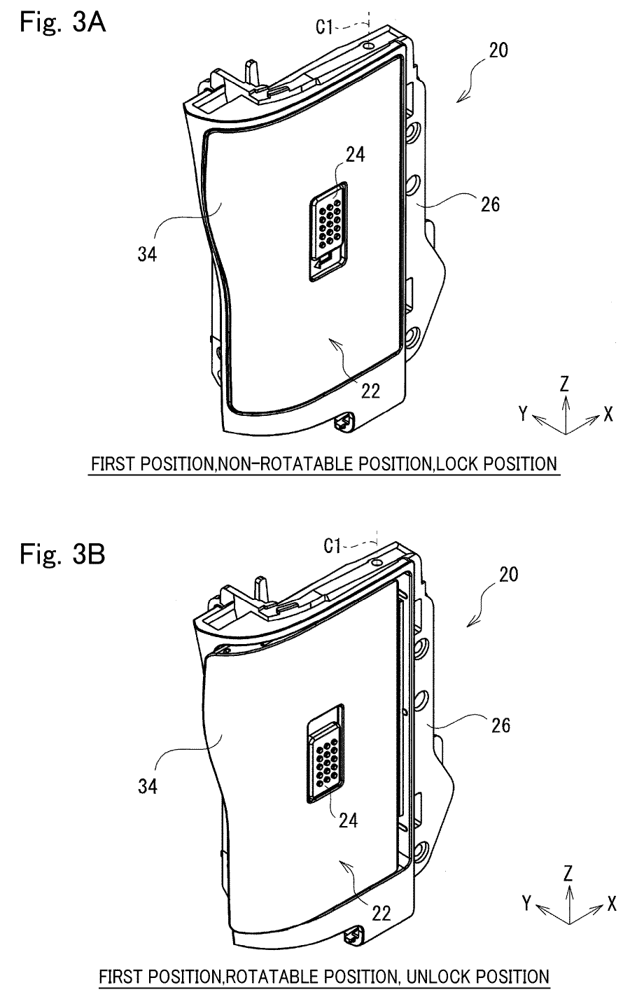

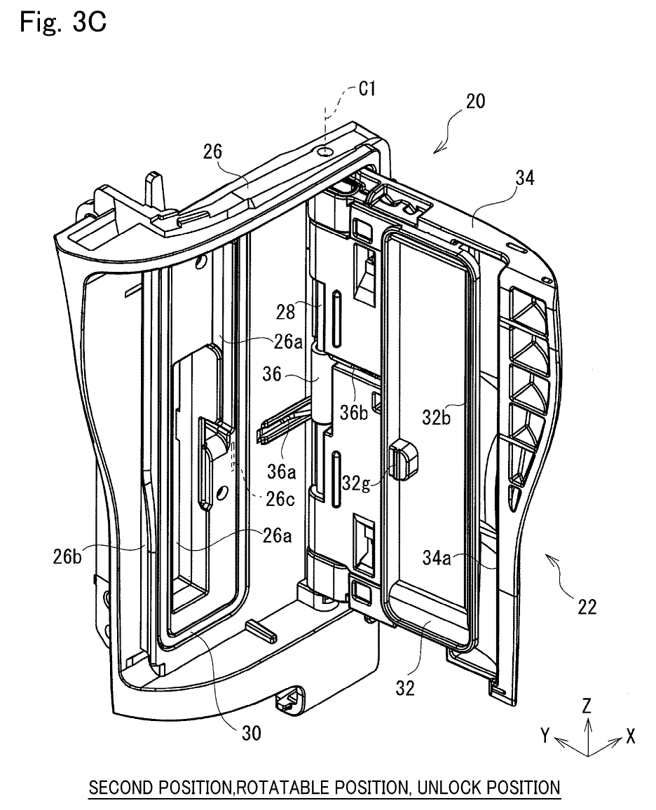

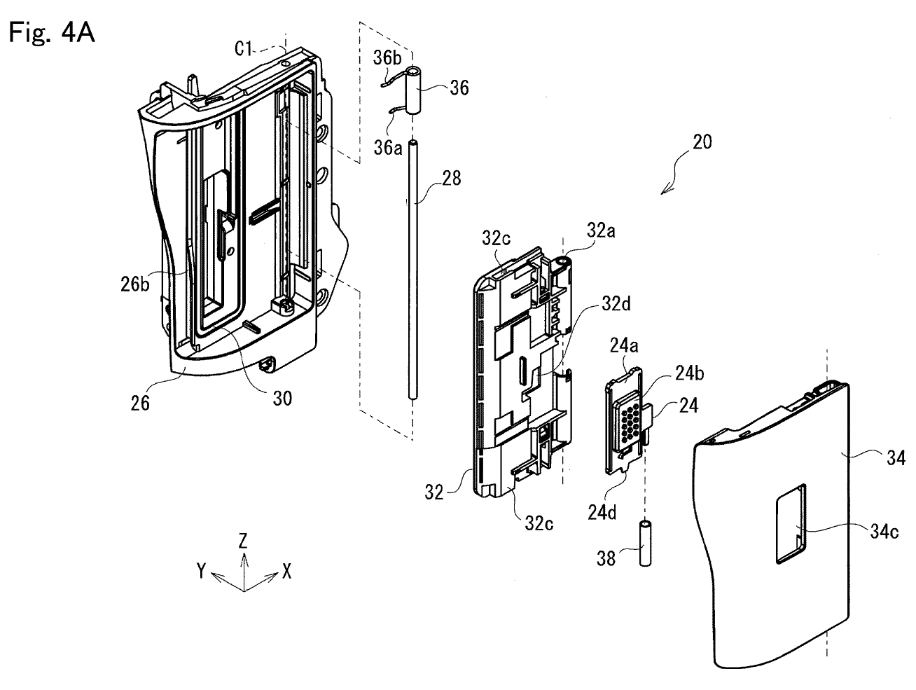

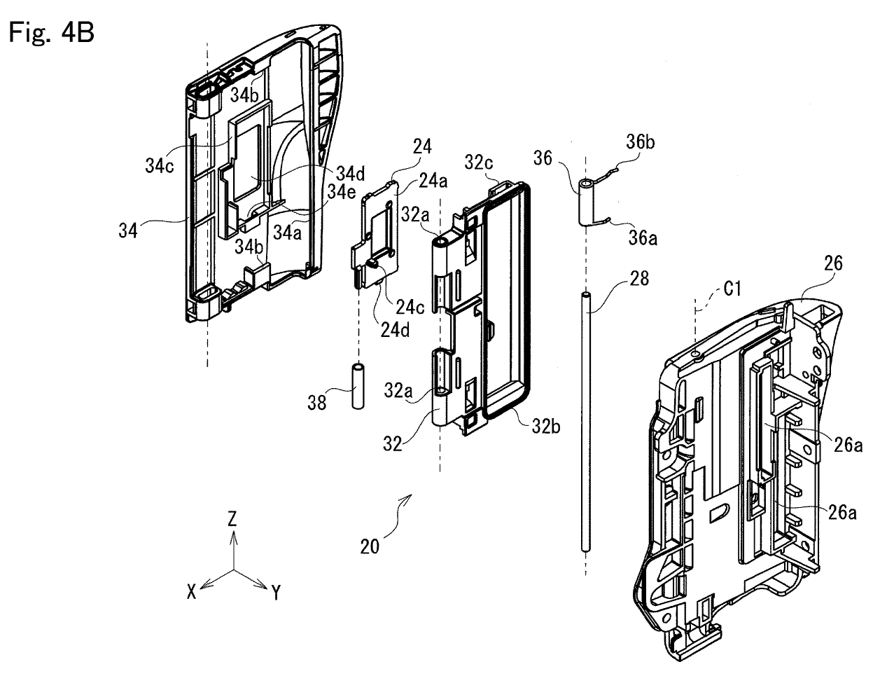

FIGS. 3A to 3C are perspective views of the cover unit. FIGS. 4A and 4B are perspective exploded views of the cover unit. Although details will be described later, FIG. 3A illustrates a state in which the cover is locked and located at the first position, FIG. 3B illustrates a state in which the cover is unlocked and located at the first position, and FIG. 3C illustrates a state in which the cover is located at the second position.

As illustrated in FIGS. 3A to 3C, 4A, and 4B, the cover unit 20 includes a cover 22 and a lock member 24 provided on the cover 22.

In the case of the present embodiment, the cover 22 is provided on a side casing 26 constituting a part of the housing 12 so as to be rotatable about a rotation center line C1 extending in the first direction. In the case of the present embodiment, the first direction is the height direction (Z-axis direction) of the imaging device 10.

Specifically, the cover 22 rotates about the rotation center line C1 by being supported by a shaft 28 extending in the height direction (Z-axis direction) of the imaging device 10 and having both ends in the height direction supported by the side casing 26. The cover 22 rotates to move between a “first position” that covers a part of the side casing 26 that is a part of the housing 12 and a “second position” that is spaced apart from the portion. FIGS. 3A and 3B illustrate the cover 22 located in the first position and FIG. 3C illustrates the cover 22 located in the second position.

In the case of the present embodiment, two insertion ports 26a into which a recording medium such as an SD card is inserted are formed in the side casing 26. In addition, an annular seal member 30 made of an elastic material such as a rubber material is provided in the side casing 26 so as to surround the two insertion ports 26a. As illustrated in FIG. 3A, when the cover 22 is located at the first position, the two insertion ports 26a are covered by the cover 22. As illustrated in FIG. 3C, when the cover 22 is located at the second position, the recording medium can be inserted into the two insertion ports 26a.

In addition, in the present embodiment, the cover 22 includes an inner member 32 and an outer member 34. As illustrated in FIG. 3A, when the cover 22 is located at the first position, the outer member 34 is exposed to the outside and constitutes a part of the outer surface (design surface) of the housing 12 of the imaging device 10. Meanwhile, the inner member 32 is not exposed to the outside when the cover 22 is located at the first position. That is, the inner member 32 is located inside with respect to the outer member 34, and the outer member 34 is located outside with respect to the inner member 32.

In the case of the present embodiment, the inner member 32 is rotatably supported by the shaft 28. Therefore, the inner member 32 is provided with a support hole 32a through which the shaft 28 passes. The inner member 32 is rotatably supported by the shaft 28 to rotate about the rotation center line C1.

In addition, as illustrated in FIG. 3C, the inner member 32 has an annular ridge portion 32b that is formed to come into contact with the seal member 30 provided on the side casing 26. As illustrated in FIG. 3A, when the cover 22 is located at the first position, the annular ridge portion 32b comes into contact with the seal member 30. As a result, the insertion port 26a of the side casing 26 is covered with the cover 22 in a state of being sealed in a fluid-tight manner.

In the case of the present embodiment, the outer member 34 is slidably supported by the inner member 32 between the “non-rotatable position” and the “rotatable position”.

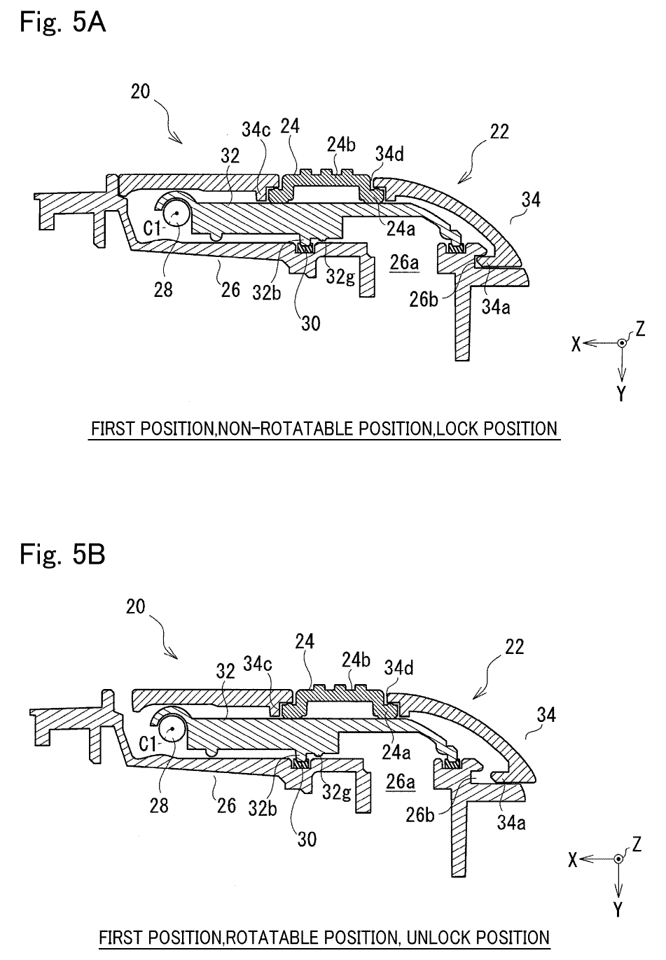

FIG. 5A is a schematic cross-sectional view of the cover unit in a state where an outer member is located at the non-rotatable position. In addition, FIG. 5B is a schematic cross-sectional view of the cover unit in a state where an outer member is located at the rotatable position. Note that FIGS. 5A and 5B are cross sections intersecting the height direction (Z-axis direction) of the imaging device 10. In addition, FIG. 5A corresponds to FIG. 3A, and FIG. 5B corresponds to FIG. 3B.

As illustrated in FIGS. 5A and 5B, the outer member 34 is slidably supported by the inner member 32 in a second direction intersecting the first direction (in the case of the present embodiment, the first direction is a height direction (Z-axis direction)) of the imaging device 10) with respect to the inner member 32. The second direction is substantially parallel to the front-rear direction (X-axis direction) of the imaging device 10 when the cover 22 is located at the first position.

As illustrated in FIG. 5A, when the cover 22 is located at the first position and the outer member 34 is located at the non-rotatable position with respect to the inner member 32, the cover 22 cannot rotate about the rotation center line C1. In the case of the present embodiment, the non-rotatable position is a position when the outer member 34 has moved to the maximum extent toward the front of the imaging device 10, in the cover unit 20 when the cover 22 is located at the first position. When the outer member 34 is located at the non-rotatable position, the outer member 34 is engaged with the housing 12, that is, the side casing 26.

Specifically, as illustrated in FIGS. 3C and 5A, the outer member 34 includes an engagement portion 34a (fourth engagement portion) provided at the distal end with respect to the rotation center line C1, and the side casing 26 includes an engagement portion 26b (third engagement portion) to be engaged with the engagement portion 34a. The engagement portion 34a of the outer member 34 and the engagement portion 26b of the side casing 26 are engaged with each other when the cover 22 is located at the first position and the outer member 34 is located at the non-rotatable position. In the case of the present embodiment, the engagement portion 34a is a claw portion that protrudes toward the front of the imaging device 10 when the cover 22 is located at the first position, and the engagement portion 26b is a recess portion that opens toward the rear of the imaging device 10 into which the claw portion can enter.

As illustrated in FIG. 5B, when the outer member 34 is located at the rotatable position, the cover 22 can rotate about the rotation center line C1. In the case of the present embodiment, the rotatable position is a position when the outer member 34 has moved to the maximum extent toward the rear of the imaging device 10, in the cover unit 20 when the cover 22 is located at the first position. When the outer member 34 is located at the rotatable position, the engagement between the outer member 34 and the side casing 26 is released. That is, the engagement portion 34a of the outer member 34 is separated from the engagement portion 26b of the side casing 26.

Note that the shapes of the engagement portion 34a of the outer member 34 and the engagement portion 26b of the side casing 26, which are engaged with each other to make the cover 22 non-rotatable, are not limited to the claw portion and the recess portion as long as they engage with each other in a separable manner in the second direction, that is, in the sliding direction of the outer member 34 with respect to the inner member 32.

In addition, in the case of the present embodiment, as illustrated in FIGS. 3C, 4A, and 4B, the cover unit 20 includes a torsion spring 36 that biases the cover 22 such that the cover 22 moves toward the second position, that is, the cover 22 rotates about the rotation center line C1 in a direction away from the side casing 26. One end 36a of the torsion spring 36 biases the side casing 26, and the other end 36b biases the inner member 32 in the cover 22. Therefore, when the outer member 34 moves to the rotatable position as illustrated in FIG. 5B, the cover 22 is biased by the torsion spring 36 and moves toward the second position.

Further, the outer member 34 is slidably supported by the inner member 32 at both ends in the first direction (in the case of the present embodiment, a height direction (Z-axis direction) of the imaging device 10).

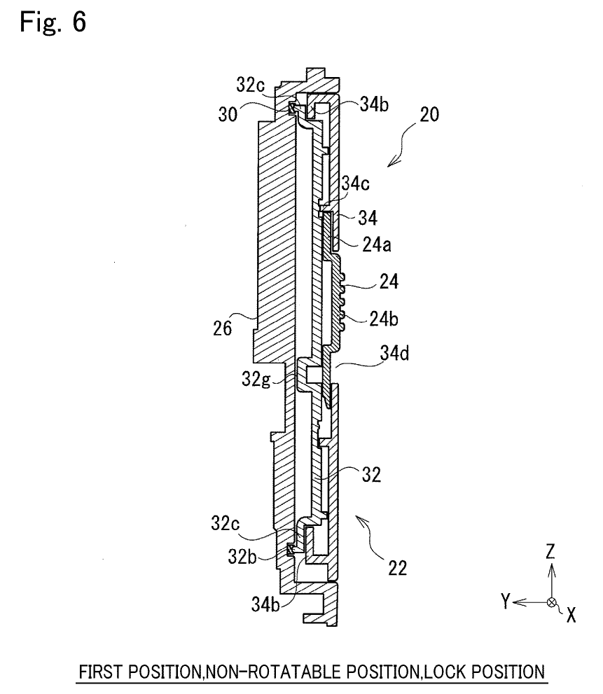

FIG. 6 is a schematic cross-sectional view of the cover unit in a state where the cover is located at the first position. Note that FIG. 6 is a cross section intersecting the front-rear direction (X direction) of the imaging device 10. In addition, FIG. 6 corresponds to FIGS. 3A and 5A.

As illustrated in FIGS. 4A, 4B and 6, in the case of the present embodiment, the inner member 32 and the outer member 34 include, respectively, an outer member support portion 32c and an inner member support portion 34b, both of which support each other at both ends in the first direction (in the case of the present embodiment, a height direction (Z-axis direction) of the imaging device 10). Specifically, the outer member support portion 32c of the inner member 32 and the inner member support portion 34b of the outer member 34 are engaged with each other and slidably support each other in a second direction intersecting the first direction (the front-rear direction (X-axis direction) of the imaging device 10 when the cover 22 is located at the first position). The shapes of the outer member support portion 32c and the inner member support portion 34b are not limited. Any shape may be adopted as long as the inner member 32 can slidably support the outer member 34 in the second direction.

The lock member 24 of the cover unit 20 is a member operated by the user, and locks the cover 22 so as not to be rotatable. The lock member 24 is provided on the cover 22 so as to be movable between the “lock position” and the “unlock position”. As illustrated in FIG. 3A, the cover 22 is not rotatable when the lock member 24 is located at the lock position. In addition, as illustrated in FIG. 3B, the cover 22 can rotate when the lock member 24 is located at the unlock position.

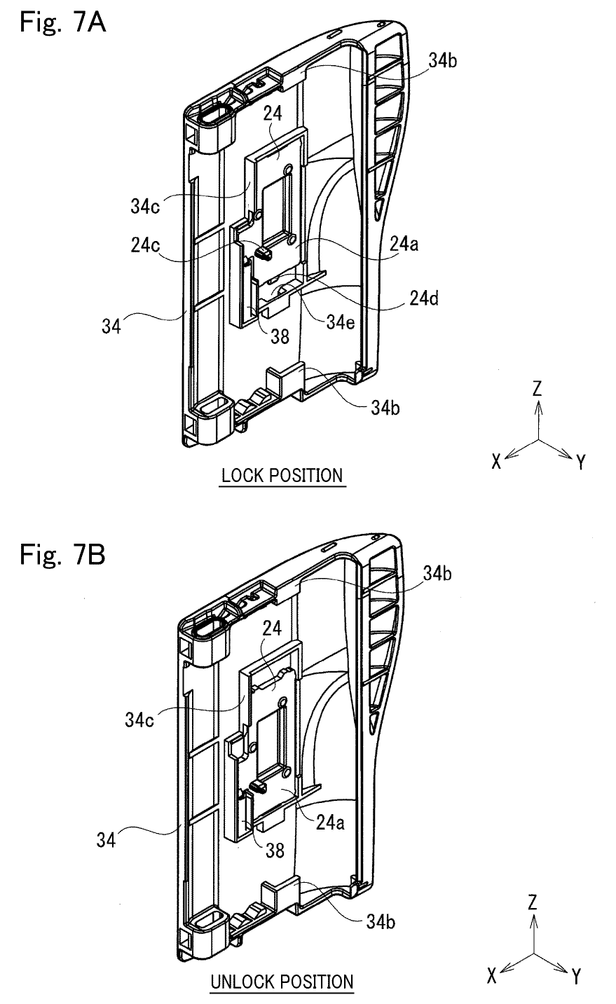

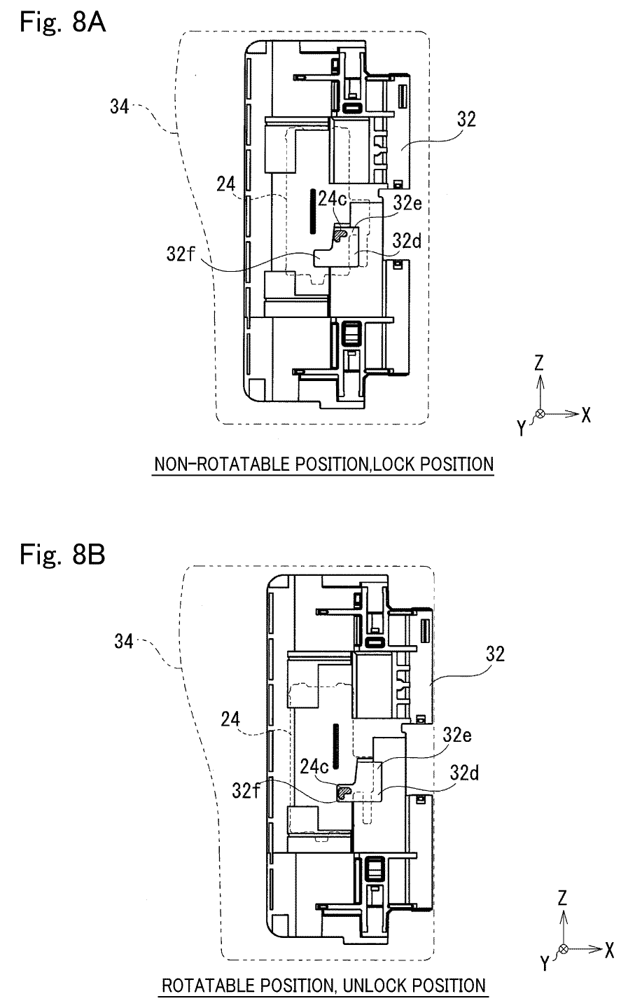

FIG. 7A is a perspective view of the outer member in a state where the lock member is located at the lock position. In addition, FIG. 7B is a perspective view of the outer member in a state where the lock member is located at the unlock position. Further, FIG. 8A is a plan view of an inner member in a state where the lock member is located at the lock position. FIG. 8B is a plan view of an inner member in a state where the lock member is located at the unlock position.

As illustrated in FIGS. 7A to 8B, 3A and 3B, in the case of the present embodiment, the lock member 24 is slidably provided on the cover 22 in the first direction (in the case of the present embodiment, a height direction (Z-axis direction) of the imaging device 10), and is located on the upper side when located at the lock position and is located on the lower side when located at the unlock position.

In addition, as illustrated in FIG. 6, the lock member 24 includes a main body portion 24a that slides in the first direction (in the case of the present embodiment, a height direction (Z-axis direction) of the imaging device 10) between the inner member 32 and the outer member 34, and a lever portion 24b that is operated by the user. As illustrated in FIGS. 7A and 7B, the main body portion 24a of the lock member 24 is guided to move in the first direction by a first lock member guide portion 34c provided on the outer member 34. In the case of the present embodiment, the first lock member guide portion 34c is an annular rib portion that houses the main body portion 24a of the lock member 24 so as to be movable only in the first direction. In addition, the lever portion 24b of the lock member 24 is exposed to the outside through a through hole 34d formed in the outer member 34 so as to be operable by the user.

Further, in the case of the present embodiment, as illustrated in FIG. 4B, the lock member 24 includes a convex portion 24c protruding toward the inner member 32. The convex portion 24c is guided to move in the first direction (in the case of the present embodiment, a height direction (Z-axis direction) of the imaging device 10) by a second lock member guide portion 32d provided on the inner member 32. In addition, the convex portion 24c is guided by the second lock member guide portion 32d so as to move in a second direction intersecting the first direction (the front-rear direction (X-axis direction) of the imaging device 10 when the cover 22 is located at the first position). In the case of the present embodiment, as illustrated in FIGS. 8A and 8B, the second lock member guide portion 32d is a substantially “L” -shaped groove composed of a first groove 32e extending in the first direction and a second groove 32f extending in the second direction.

Therefore, when the lock member 24 is located at the lock position, the convex portion 24c of the lock member 24 exists in the first groove 32e of the second lock member guide portion 32d of the inner member 32 as illustrated in FIG. 8A. In this state, the outer member 34 cannot move in the second direction (the front-rear direction (X-axis direction) of the imaging device 10 when the cover 22 is located at the first position).

When the lock member 24 is moved from the lock position to the unlock position by a user operation, as illustrated in FIG. 8B, the convex portion 24c moves from the first groove 32e into the second groove 32f. As a result, the outer member 34 can slide in the second direction (the front-rear direction (X-axis direction) of the imaging device 10 when the cover 22 is located at the first position) with respect to the inner member 32, that is, can move from the non-rotatable position to the rotatable position.

Therefore, in the case of the present embodiment, the lock member 24 indirectly locks the cover 22 via the outer member 34 such that the cover 22 is not rotatable.

In the case of the present embodiment, the lock member 24 is biased toward the lock position by a coil spring 38 as illustrated in FIGS. 4A, 4B, 7A and 7B. Specifically, the main body portion 24a of the lock member 24 is biased from below by the coil spring 38.

As illustrated in FIG. 6, and as described above, in the cover 22, the inner member 32 and the outer member 34 support each other at both ends in the first direction (in the case of the present embodiment, a height direction (Z-axis direction) of the imaging device 10). Therefore, when pressed in a third direction intersecting both the first direction and the second direction (the front-rear direction (X-axis direction) of the imaging device 10 when the cover 22 is located at the first position), the inner member 32 of the cover 22 easily undergoes bending deformation. The third direction is an overlapping direction of the inner member 32 and the outer member 34, and is substantially parallel to the left-right direction (Y-axis direction) of the imaging device 10 when the cover 22 is located at the first position.

For example, when the user slides the lock member 24 from the lock position to the unlock position against the biasing force of the coil spring 38, the user strongly presses the lock member 24 such that the finger does not slip on the lever portion 24b of the lock member 24. As a result, the lock member 24 is displaced toward the inner member 32, and the inner member 32 undergoes bending deformation by being pushed by the displaced lock member 24. When the inner member 32 undergoes bending deformation, the outer member 34 may not slide with respect to the inner member 32. In addition, when the lock member 24 is displaced in the pressing direction, that is, when the lock member 24 sinks, the user who tries to slide the lock member 24 in the direction intersecting the pressing direction may feel uncomfortable.

As a countermeasure, for example, it is conceivable to increase the thickness to improve the flexural rigidity of the inner member 32. In addition, for example, it is conceivable to support the inner member 32 such that the inner member 32 does not undergo bending deformation by another member (for example, made of a metal material) having high rigidity. However, in the case of these measures, the thickness of the entire cover 22 increases, and as a result, the entire imaging device 10 increases in size.

As illustrated in FIGS. 3C, 5A, 5B and 6, in order to suppress excessive bending deformation of the cover 22 when the user presses the lock member 24, the cover 22 is provided with a contact portion 32g that protrudes toward the housing 12 and contacts the housing 12. In the case of the present embodiment, the contact portion 32g is a convex portion, and is provided in a portion of the inner member 32 facing the side casing 26 when the cover 22 is located at the first position. Specifically, as illustrated in FIG. 3C, the contact portion 32g is provided in the annular ridge portion 32b, and thus, a portion 26c of the side casing 26 in contact with the contact portion 32g of the inner member 32 is surrounded by a seal member 30.

As illustrated in FIGS. 5A, 5B and 6, when the cover 22 is located at the first position, at least a part of the contact portion 32g of the inner member 32 faces at least a part of the lock member 24. When the lock member 24 is pressed by the user, the contact portion 32g of the inner member 32 positioned between the side casing 26 and the lock member 24 is displaced toward the side casing 26 and comes into contact with the side casing 26. As a result, excessive bending deformation of the inner member 32 is suppressed, and excessive displacement of the lock member 24 in the pressing direction, which may provide a sense of discomfort to the user, is suppressed.

As illustrated in FIGS. 5A, 5B and 6, in the case of the present embodiment, when the cover 22 is located at the first position, the annular ridge portion 32b of the inner member 32 is in contact with the side casing 26 via the seal member 30. Meanwhile, when the inner member 32 is in a natural state of not receiving an external force, the contact portion 32g of the inner member 32 is not in contact with the side casing 26. As a result, the annular ridge portion 32b can be reliably brought into contact with the seal member 30 at a predetermined contact pressure, and the insertion port 26a of the recording medium can be covered in a state of being securely sealed in a fluid tight manner.

In contrast, when the inner member 32 is in a natural state and the contact portion 32g comes into contact with the side casing 26, the annular ridge portion 32b of the inner member 32 may not come into contact with the seal member 30 at a predetermined contact pressure due to manufacturing variation in the protrusion height of the contact portion 32g. For example, when the protrusion height of the contact portion 32g is higher than an appropriate height, a gap may be generated between the annular ridge portion 32b of the inner member 32 and the seal member 30.

Therefore, when the inner member 32 slightly undergoes bending deformation by the user pressing the lock member 24, the contact portion 32g of the inner member 32 is displaced toward the side casing 26 and comes into contact with the side casing 26, and the excessive bending deformation of the inner member 32 is suppressed.

When the cover 22 is located at the first position, the contact portion 32g of the inner member 32 faces the side casing 26, and thus, the inner member 32 slightly undergoes bending deformation by the user pressing the lock member 24, allowing the contact portion to contact the side casing 26. However, when the cover 22 is located at the second position, since the inner member 32 does not face the side casing 26, the contact portion 32g cannot contact the side casing 26.

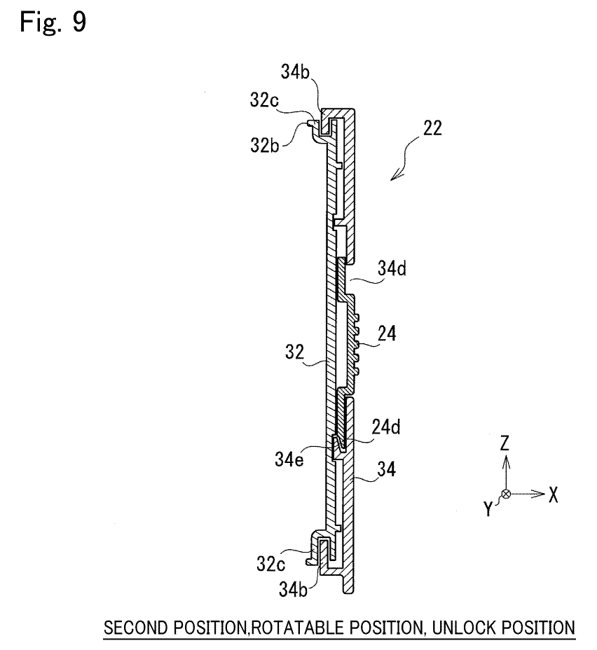

FIG. 9 is a cross-sectional view of the cover in a state of being located at the second position.

As illustrated in FIG. 9, when the cover 22 is located at the second position, the lock member 24 is located at the unlock position. The lock member 24 and the outer member 34 engage with each other in the first direction (in the case of the present embodiment, the height direction (Z-axis direction) of the imaging device 10) when the lock member 24 is located at the unlock position. Therefore, as illustrated in FIGS. 4B, 7A and 9, the lock member 24 includes an engagement portion 24d (second engagement portion), and the outer member 34 includes an engagement portion 34e (first engagement portion) to be engaged with the engagement portion 24d. In the present embodiment, the engagement portion 24d of the lock member 24 is a tongue-shaped protrusion portion protruding downward from the main body portion 24a, and the engagement portion 34e of the outer member 34 is a hole. The shapes of the engagement portions 24d and 34e are not limited as long as they can be engaged with each other in the first direction.

As illustrated in FIG. 9, when the lock member 24 is located at the unlock position, the engagement portion 24d of the lock member 24 is engaged with the engagement portion 34e of the outer member 34. Due to the engagement, displacement of the lock member 24 with respect to the outer member 34 in the third direction (overlapping direction of the inner member 32 and the outer member 34) is restricted. Accordingly, when pressed by the user, the lock member 24 cannot be displaced toward the inner member 32. As a result, when the cover is not located at the first position, the bending deformation of the inner member 32 is suppressed.

The present embodiment as described above can suppress deformation of a cover when a user operates the lock member in an imaging device in which the cover that covers a part of a housing is provided with the lock member that locks the cover in a non-displaceable manner. That is, in the case of the present embodiment, if the cover is located at either the first position or the second position, deformation of the cover when the user operates the lock member can be suppressed.

Although the embodiments of the present disclosure have been described with reference to the above-described embodiments, the embodiments of the present disclosure are not limited thereto.

For example, in the case of the above-described embodiment, the cover 22 is rotatably supported by the housing 12 in order to cover the insertion port 26a of the recording medium, the insertion port provided in the housing 12 (side casing 26). In addition, the lock member 24 restricts the movement of the outer member 34 of the cover 22 engaged with the housing 12, thereby locking the cover 22 such that the cover 22 is not rotatable. However, the embodiment of the present disclosure is not limited thereto.

For example, the cover according to the embodiment of the present disclosure may be a cover that is provided in a housing of an imaging device and covers a terminal to which a power cable, an image output cable, and the like are connected, an insertion opening for a battery, and the like.

In addition, for example, the cover according to the embodiment of the present disclosure may be a cover detachably provided to the housing of the imaging device. In this case, for example, the lock member is slidably provided on the cover, and the lock member directly engages the housing when the lock member is located in the lock position, thereby making the cover non-displaceable, that is, non-removable, with respect to the housing. When the lock member is in the unlock position, the lock member is disengaged from the housing, allowing the cover to be displaced with respect to the housing, that is, the cover to be removed from the housing.

That is, the imaging device according to the embodiment of the present disclosure is an imaging device, in a broad sense, including:

a housing; a cover provided on the housing to be displaceable between a first position covering a part of the housing and a second position spaced apart from the part of the housing; and a lock member provided on the cover so as to be movable between a lock position and an unlock position, the lock member being operated by a user, in which the cover in the first position is non-displaceable when the lock member is located in the lock position and the cover in the first position is displaceable when the lock member is located in the unlock position; and the cover and the lock member respectively include first and second engagement portions that engage with each other in a moving direction of the lock member when the lock member is located at the unlock position.

As described above, the above-described embodiments have been described as examples of the technique in the present disclosure. To that end, the drawings and detailed description are provided. Therefore, the components described in the drawings and the detailed description may include not only components essential for solving the problem but also components that are not essential for solving the problem in order to illustrate the above-described technology. Therefore, it should not be immediately recognized that these non-essential components are essential based on the fact that these non-essential components are described in the drawings and the detailed description.

In addition, since the above-described embodiments are intended to illustrate the technique in the present disclosure, various changes, replacements, additions, omissions, and the like can be made within the scope of the claims or equivalents thereof.

The present disclosure is applicable to an imaging device in which a cover is provided to be displaceable with respect to a housing and covers a part of the housing, and a lock member that locks the cover in a non-displaceable manner is provided in the cover.

What is claimed is:

1. An imaging device comprising:
a housing;
a cover provided on the housing to be displaceable between a first position covering a part of the housing and a second position spaced apart from the part of the housing; and
a lock member provided on the cover so as to be movable between a lock position and an unlock position, the lock member being operated by a user,
wherein
the cover in the first position is non-displaceable when the lock member is located in the lock position and the cover in the first position is displaceable when the lock member is located in the unlock position; and
the cover and the lock member respectively include first and second engagement portions that engage with each other in a moving direction of the lock member when the lock member is located at the unlock position.

2. The imaging device according to claim 1, wherein the cover is rotatably supported by the housing.

3. The imaging device according to claim 2, wherein
the cover includes:
an inner member rotatably supported by the housing about a rotation center line extending in a first direction; and
an outer member slidably supported by the inner member in a second direction intersecting the first direction between a non-rotatable position and a rotatable position,
the housing and the outer member respectively include third and fourth engagement portions that engage with each other in the second direction when the cover is located at the first position and the outer member is located at the non-rotatable position to restrict rotation of the cover, and
when the outer member in the cover located at the first position is located at the non-rotatable position, the lock member located at the lock position restricts sliding of the outer member from the non-rotatable position to the rotatable position.

4. The imaging device according to claim 3, wherein
the outer member includes a first lock member guide portion that guides a part of the lock member to move in the first direction, and
the inner member includes a second lock member guide portion that guides another part of the lock member to move in the first direction and to move in the second direction.

5. The imaging device according to claim 3, wherein
the outer member includes the first engagement portion, and
when the lock member is located at the unlock position, the first engagement portion of the outer member and the second engagement portion of the lock member are engaged with each other in the first direction.

6. The imaging device according to claim 3, wherein the outer member is slidably supported by the inner member in the second direction at both ends in the first direction.

7. The imaging device according to claim 1, wherein an insertion port into which a storage medium is inserted is provided in the part of the housing.
